(19) United States
(12) Patent Application Publication
(10) Pub. No.: US 2006/0205591 A1
(43) Pub. Date: Sep. 14, 2006

(54) Adsorbent for removing mercury using sulfided iron compounds containing oxygen and method of producing same

(76) Inventors: Do-Hee Lee, Cheonan-si (KR); Hyun-Ki Lee, Asan-si (KR); Min-Soo Bae, Pohang-si (KR); Hyun-Myung Oh, Cheonan-si (KR); Jihn-Koo Lee, Cheonan-si (KR); Du-Soung Kim, Seoul (KR)

Correspondence Address: SHERIDAN ROSS PC, 1560 BROADWAY, SUITE 1200, DENVER, CO, 80202, US

(21) Appl. No.: 11/203,443

(22) Filed: Aug. 12, 2005

(30) Foreign Application Priority Data
Mar. 11, 2005 (KR) 10-2005-0020374

(51) Int. Cl. B01J 20/00

(52) U.S. Cl. 502/400

(57) ABSTRACT

Disclosed herein is an adsorbent for removing mercury, which comprises sulfided iron compounds containing oxygen. In the adsorbent, iron compounds containing oxygen are sulfided to accumulate sulfur therein, thereby removing gaseous mercury.

### BACKGROUND OF THE INVENTION

1. Field of the Invention

The present invention relates, in general, to an adsorbent for adsorbing and removing mercury and, more particularly, to an adsorbent for removing mercury using sulfided iron compounds containing oxygen and a method of producing the same.

2. Description of the Related Art

In accordance with accelerated industrialization after the industrial revolution, environmental pollution problems have rapidly been aggravated. Particularly, heavy metals discharged from a pollutant source give rise to serious worries. Among them, mercury has characteristics unlike other heavy metals, such as high volatility, strong harmfulness, and accumulation in the human body, thus it has been considered as a major pollutant. When it is discharged from a combustion device to atmospheric air, it is known to be almost completely discharged in a gas element state, unlike other heavy metals which are typically discharged in particulate form.

According to current EPA (The U.S. Environmental Protection Agency) data, methods of removing mercury are classified into an activated carbon injection method, a carbon filter bed method, a selenium filter method, a treated activated carbon adsorption method, a wet scrubbing method, and the like. Among them, the method employing activated carbon has been frequently studied, but is problematic in that, since about 100,000 g of activated carbon must be used to remove 1 g of mercury, cost is increased, and although physically adsorbed mercury may be desorbed from the activated carbon, and it must be hermetically buried in an independent location.

Many researchers have studied the use of sulfur in order to remove mercury, and studies of the addition of sulfur to oxides or hydroxides have frequently been made. In addition to the deposition of sulfur on activated carbon, recently, a method of depositing sulfur on a mesoporous substance to remove mercury has been suggested. However, the method has limited commercial value because of its high cost.

Accordingly, in the present invention, iron compounds containing oxygen which compared with other oxides, is capable of being produced at low cost is employed as a mercury adsorbent. The iron compounds containing oxygen are sulfided to compensate for its low mercury adsorbing ability, thereby maximizing its mercury adsorbing ability.

With respect to sulfidation, harmful hydrogen sulfide is discharged from industrial facilities, such as incinerators or power plants in landfills. Hydrogen sulfide which pollutes atmospheric air must be appropriately removed according to discharge regulations. Iron compounds containing oxygen may be used as the adsorbent for removing hydrogen sulfide, thereby spontaneously depositing sulfur on iron compounds containing oxygen. Using the above-mentioned mechanism, pollutants can be removed in conjunction with the sulfidation of low-priced iron compounds containing oxygen, and the waste adsorbent can be reused as the adsorbent for mercury, thereby assuring a resource regeneration effect.

Currently, there is increased interest in the protection of the environment and the reuse of resources, therefore interest in the reuse of industrial wastes is growing. Particularly, there is high interest in the reuse of waste iron compounds containing oxygen which occupies a high proportion of industrial wastes. However, since reuse technologies have been insufficiently developed, all industrial waste is being buried under ground, causing resources to be wasted.

Ferrous sulfate and ferric sulfate are hydrolyzed or treated with alkali to produce an iron compounds containing oxygen pigment, and are used as an aggregating agent in wastewater treatment, or, occasionally, are used as magnetic material or ferrite. However, in comparison with the amount of ferrous sulfate and ferric sulfate generated during a process of producing steel and titanium dioxide, the requirement and number of users for them are small, thus they are undesirably wasted in great amounts. Therefore, polyferric sulfate trades at a low price of 45 won/kg. The composition of the polyferric sulfate solution is described in Table 1.

TABLE 1
Composition of polyferric sulfate solution

| | Specific | Fe³⁺ | (SO₄)²⁻ | |
|---|---|---|---|---|
| | gravity | concentration | concentration | pH |
| Polyferric | 1.45 | 11% or more | 22% or more | 0.1-1.0 |
| sulfate | | | | |

Iron compounds containing oxygen may be generated as a byproduct in the course of treating a solution which is generated when scales and pollutants on surfaces of steel plates are washed with 18% hydrochloric acid in order to convert hot-rolled steel plates into cold-rolled steel plates during an iron manufacturing process, or may be produced from polyferric sulfate generated during a process of producing titanium oxide using a sulfuric acid method.

The present invention provides a method in which iron compounds containing oxygen are produced at low price to remove mercury and then sulfided to be used as a mercury adsorbent.

### SUMMARY OF THE INVENTION

Accordingly, the present invention has been made keeping in mind the above problems occurring in the prior art, and an object of the present invention is to provide an adsorbent for removing mercury, in which iron compounds containing oxygen are sulfided, and a method of producing the same.

Another object of the present invention is to provide an adsorbent for removing mercury and a method of producing the same, in which iron compounds containing oxygen are created from polyferric sulfate generated in the course of producing titanium oxide using ilmenite, and is sulfided to adsorb mercury from exhausted gas and thus remove it.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a flow chart showing the production of an adsorbent for removing mercury according to the present invention; and

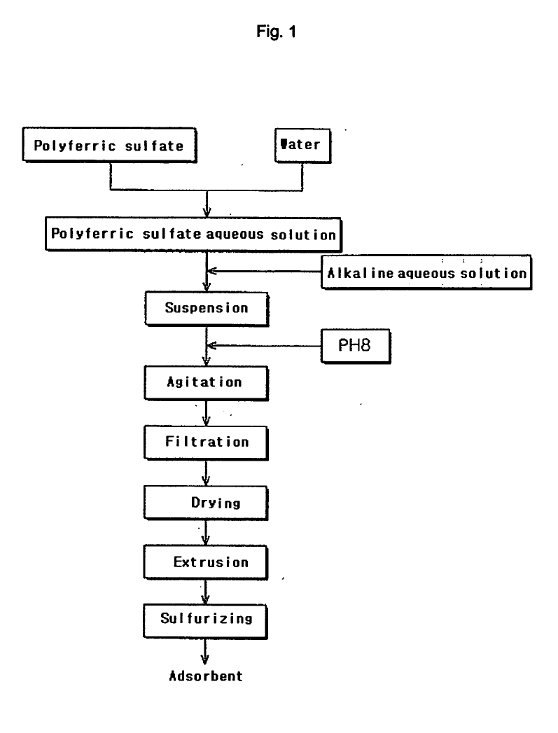

FIG. 2 illustrates XRD results of iron compounds containing oxygen produced according to examples 1 to 4 of the present invention.

### DESCRIPTION OF THE PREFERRED EMBODIMENTS

According to an aspect of the present invention, there is provided an adsorbent for removing mercury, which comprises sulfided iron compounds containing oxygen. According to another aspect of the present invention, there is provided a method of producing an adsorbent for removing mercury, which comprises sulfided iron compounds containing oxygen.

Mercury which is treated with the adsorbent for removing mercury according to the present invention means general gaseous mercury, preferably gaseous mercury contained in exhausted gas, and more preferably gaseous mercury contained in gas exhausted from power plants or incinerators, or gaseous mercury which is exhausted from a mercury battery, a fluorescent mercury lamp, or an amalgam in dental service. In detail, it means gaseous mercury containing Hg⁰, HgCl, or HgCl₂.

As long as iron compounds containing oxygen which constitutes the adsorbent for removing mercury according to the present invention is capable of being sulfided to be used as the adsorbent, any type of iron compounds containing oxygen may be used. Iron compounds containing oxygen may be exemplified by FeO, Fe(OH)₂, Fe(OH)₃, FeO(OH), Fe₂O₃, and Fe₃O₄, and preferably includes amorphous spherical particles having an FeO(OH) structural formula.

Iron compounds containing oxygen according to the present invention is produced from polyferric sulfate. A brief outline of a procedure for producing iron compounds containing oxygen from polyferric sulfate is as follows: First, polyferric sulfate and an alkaline aqueous solution are prepared at a predetermined concentration, mixed, and agitated to produce a suspension. After the suspension is filtered and washed to create a product, the product is dried to produce iron compounds containing oxygen as a final product.

Any polyferric sulfate typically used in the art may be used as polyferric sulfate employed herein. It is preferable to use polyferric sulfate which is generated during a process of producing titanium oxide using ilmenite, polyferric sulfate which is produced using a byproduct of titanium oxide, that is, solid ferrous sulfate, as raw material, or polyferric sulfate in the form of waste slag which is produced by mixing water and sulfuric acid with iron compounds containing oxygen (Fe₂O₃) during an acid rinsing step in the course of producing steel. It is more preferable to use polyferric sulfate which is generated during the process of producing titanium oxide using ilmenite.

Particularly, iron compounds containing oxygen, produced using ferrous sulfate and ferric sulfate as raw material or pigment, has very poor physical properties as an adsorbent, but iron compounds containing oxygen which is produced according to the present invention has physical properties superior to conventional iron compounds containing oxygen.

In the present invention, any alkaline aqueous solution may be used as long as it is capable of neutralizing polyferric sulfate. It is exemplified by ammonium carbonate [(NH₄)₂CO₃], ammonium bicarbonate (NH₄HCO₃), ammonia (NH₃), sodium hydroxide (NaOH), or a mixture thereof. Particularly, it is preferable to use ammonium bicarbonate or sodium hydroxide.

The adsorbent for removing mercury according to the present invention is made from iron compounds containing oxygen which is introduced from polyferric sulfate, that comes into contact with gas containing sulfur, and as a result it generates iron sulfide and a sulfur element. Iron sulfide and the sulfur element react with gaseous mercury to generate mercury sulfide (HgS).

As a method of sulfurizing iron compounds containing oxygen according to the present invention to form iron sulfide, any method may be used as long as the method comprises exposing iron compounds containing oxygen to a gas or solution containing sulfur. Particularly, a method of vaporizing a sulfur element at high temperature to be exposed to iron compounds containing oxygen so as to form iron sulfide, or a method which comprises impregnating iron compounds containing oxygen with a solution containing sulfur, drying and sintering the resulting solution so that sulfur is deposited, or a method of exposing iron compounds containing oxygen to gas, such as hydrogen sulfide, so that hydrogen sulfide is adsorbed may be used as the method of exposing iron compounds containing oxygen to gas containing sulfur. It is more preferable to expose iron compounds containing oxygen to hydrogen sulfide so that hydrogen sulfide as a substance having an offensive odor is treated and iron sulfide is formed.

In the method of exposing iron compounds containing oxygen to hydrogen sulfide so as to sulfurize iron compounds containing oxygen, hydrogen sulfide may be intentionally injected into iron compounds containing oxygen. However, in consideration of economic efficiency and treatment of waste gas generated in industrial facilities, it is preferable to expose iron compounds containing oxygen to a flow path of hydrogen sulfide which is generated from power plants in landfills, oil refining factories, human manure treatment factories, or wastewater treatment factories, so that hydrogen sulfide is adsorbed and thus removed, thereby treating hydrogen sulfide generated from a pollution source and spontaneously sulfurizing iron compounds containing oxygen.

Therefore, the term “sulfidation” used in the present invention is intended to include a process of dipping the adsorbent in a solution containing sulfur, a process of vaporizing the sulfur element, and a process of continuously supplying a gas containing a sulfur compound to iron compounds containing oxygen.

Hereinafter, a detailed description of a method of producing an adsorbent for removing mercury according to the present invention will be given. Any typical iron compounds containing oxygen may be used as the adsorbent for removing mercury according to the present invention. However, in order to easily describe the present invention herein, a description will be given of an adsorbent for removing mercury using a specific iron compounds containing oxygen which is produced from polyferric sulfate.

The method of producing the adsorbent for removing mercury according to the present invention comprises i) mixing and agitating polyferric sulfate and water to produce polyferric sulfate aqueous solution at a concentration of 0.5-1 M having pH of 1-2, ii) continuously dropping 1-2 M alkaline aqueous solution into the polyferric sulfate aqueous solution of step i) to slowly increase the pH of polyferric sulfate aqueous solution, thereby creating a suspension, iii) increasing the pH of the suspension of step ii) to about 8, stopping the addition of the alkaline aqueous solution, and agitating the suspension so that its pH is maintained at about 8 for about 1 hour, iv) filtering a precipitate using ultra-pure water after step iii) is completed, v) drying the precipitate of step iv) at about 100-150° C. to produce iron compounds containing oxygen, and vi) sulfurizing the iron compounds containing oxygen of step v).

If necessary, the method may further comprise extruding the adsorbent for removing mercury between steps v) and vi) or after step vi), and, in this step, the final adsorbent for removing mercury is shaped into balls, pellets, or honeycombs depending on its application and usage. In detail, in the extrusion step, iron compounds containing oxygen dried through step v) is extruded and then sulfided, or the adsorbent for removing mercury is finally extruded after the sulfidation of step vi) is completed. It is preferable that the dried iron compounds containing oxygen be extruded and then sulfided.

In the present invention, any alkaline aqueous solution may be dropped into the polyferric sulfate aqueous solution as long as it is capable of neutralizing polyferric sulfate. Preferably, ammonium carbonate, ammonium bicarbonate, ammonia, sodium hydroxide, or a mixture thereof, and more preferably, ammonium bicarbonate, may be dissolved in water so that the concentration is 1 M.

In the course of drying the precipitate of step v), the drying temperature affects the structure of iron compounds containing oxygen. When the drying temperature is rapidly increased, or when the drying is conducted at 150° C. or higher, the structure of iron compounds containing oxygen are converted from FeO(OH) to Fe₂O₃, thus the drying temperature must be maintained at 150° C. or lower, preferably 100-150° C., and more preferably 110-120° C., and the drying temperature of the precipitate must be maintained at high temperature after it is slowly increased from low temperature.

Iron compounds containing oxygen produced according to the present invention is extruded, thereby determining the shape of adsorbent for removing mercury. Any extrusion method may be employed as long as it is an extrusion method typically used in the art. Preferably, produced a iron compounds containing oxygen or sulfided iron compounds containing oxygen are milled to produce fine powder, and the fine powder is mixed with a typical organic or inorganic bonding agent, such as methylcellulose, PVA (polyvinyl alcohol), or dextrin, and a crosslinking agent, such as alumina sol or colloidal silica, and extruded using an extruder, thereby creating the adsorbent for removing mercury.

As described above, the adsorbent for removing mercury according to the present invention is used as an adsorbent for adsorbing and removing gaseous mercury, and preferably gaseous mercury contained in exhausted gas, or is used to adsorb and remove pollutants similar to mercury, for example, heavy metals.

A better understanding of the present invention may be obtained through the following examples which are set forth to illustrate, but are not to be construed as the limit of the present invention.

### EXAMPLE 1

### Production of Iron Compounds Containing Oxygen

78 ml of polyferric sulfate solution [Cosmo Chemical Co., Ltd., Korea] containing 11 % Fe³⁺ ions was mixed with 427 ml of water to produce polyferric sulfate aqueous solution at a concentration of 0.5 M (based on Fe³⁺).

Next, the pH of the polyferric sulfate aqueous solution was maintained at 1-2, and agitation was conducted using an agitator [CENMAG MIDI, KIKA Works, Malaysia] at 600-800 rpm for about 60 min.

Subsequently, 96 g of ammonium carbonate [Duksan Pure Chemicals Inc., Korea] was dissolved in 1000 ml of water to produce an alkaline aqueous solution at a concentration of 1M. The above alkaline aqueous solution was dropped into the polyferric sulfate aqueous solution.

When the above alkaline aqueous solution is dropped, precipitates may be formed, causing agglomeration of particles. Accordingly, the polyferric sulfate aqueous solution was vigorously agitated using the agitator at an agitation rate of 320 rpm or more, and the alkaline aqueous solution was slowly dropped at a rate of about 0.084 ml/s, so as to suppress the agglomeration of precipitates.

When the alkaline aqueous solution was dropped into the polyferric sulfate aqueous solution, the pH of the polyferric sulfate aqueous solution was increased to about 3 to produce a red brown suspension.

Next, the alkaline aqueous solution was continuously dropped so that the pH of the red brown suspension was slowly increased to 8. The dropping of alkaline aqueous solution was stopped when the pH of the suspension reached 8. While the agitation was continued for 1 hour or more the pH of the suspension was observed. The agitation of the suspension was stopped when the pH of the suspension did not change any more.

Next, the precipitates were filtered a few times using ultra-pure water in order to remove anions contained in the suspension, and then dried at about 110° C. to produce 22.5 g of iron compounds containing oxygen.

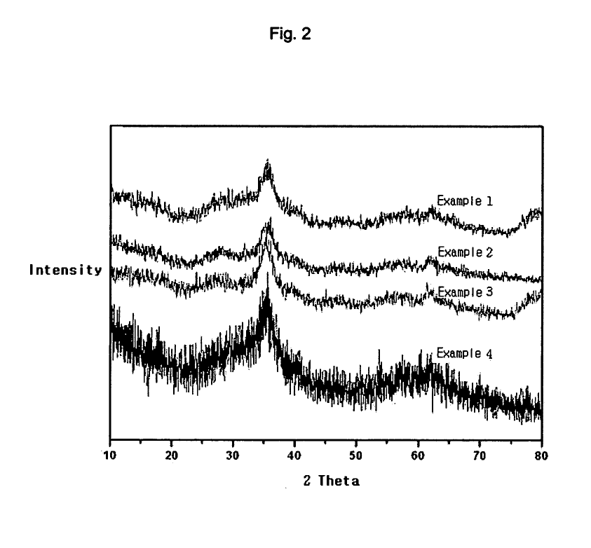

The physical properties of the produced iron compounds containing oxygen were analyzed using XRD [RINT2200, Rigaku, Japan] and BET [ASAP2010, Micrometrics, USA], and the results are shown in Table 2 and FIG. 2.

As shown in FIG. 2, produced iron compounds containing oxygen were almost all amorphous with little crystallinity. From the BET analysis results, it can be seen that produced iron compounds containing oxygen had a specific surface area of 360-430 m²/g, a pore volume of 0.24-0.46 cm³/g, and a pore diameter of 2.5-4.5 nm.

TABLE 2
BET analysis results

| | | BJH cumulative | |
|---|---|---|---|
| | BH cumulative | desorption | BJH desorption |
| | desorption surface | pore volume | average pore |
| | area(m²/g) | of pores(cm³/g) | diameter(nm) |
| Iron compounds | 424.26 | 0.46 | 4.375 |
| containing | | | |
| oxygen | | | |

### EXAMPLE 2

### Production of Iron Compounds Containing Oxygen

The procedure of example 1 was repeated except that 1M alkaline aqueous solution comprising ammonium bicarbonate (NH₄HCO₃) [Duksan Pure Chemicals Inc., Korea] was used instead of 1M alkaline aqueous solution comprising ammonium carbonate.

The results are shown in FIG. 2.

### EXAMPLE 3

### Production of Iron Compounds Containing Oxygen

The procedure of example 1 was repeated except that 1M alkaline aqueous solution comprising ammonia (NH₃) [Duksan Pure Chemicals Inc., Korea] was used instead of 1M alkaline aqueous solution comprising ammonium carbonate.

The results are shown in FIG. 2.

### EXAMPLE 4

### Production of Iron Compounds Containing Oxygen

The procedure of example 1 was repeated except that 1M alkaline aqueous solution comprising sodium hydroxide (NaOH) (Duksan Pure Chemicals Inc., Korea] was used instead of 1M alkaline aqueous solution comprising ammonium carbonate.

The results are shown in FIG. 2.

As shown in FIG. 2, the resulting iron compounds containing oxygen was amorphous with little crystallinity.

### EXAMPLE 5

### Sulfidation of Iron Compounds Containing Oxygen and Removal of Hydrogen Sulfide

First, a glass reactor was manufactured as follows. An inlet and an outlet were positioned opposite each other, the diameter was 36 mm, and the height was 200 mm. 60 cm³ of iron compounds containing oxygen produced according to example 1 was packed therein.

Subsequently, hydrogen sulfide gas which contained a balance of 10 % H₂S/N₂ was fed through the inlet of the glass reactor at a concentration of 2 % based on the total flow rate at a flow rate of 1000 cm³/min to sulfurize iron compounds containing oxygen, thereby creating an adsorbent for removing mercury.

Next, the concentration of hydrogen sulfide in the gas exhausted through the outlet was measured using a detector tube [4LL, Gastech, Japan). The point when the concentration of leaked hydrogen sulfide was 10 ppm (TLV) was taken as a breakthrough point. The TLV (threshold limit value) is an index established by ACGIH (American Conference of Governmental industrial Hygienists, Inc.), which indicates the degree of safety of harmful gas discharged from industrial facilities based on the degree of leakage of harmful gas. Through the above method, the ability of iron compounds containing oxygen to adsorb hydrogen sulfide was evaluated.

Furthermore, after the gas leaked at the level of TLV or more, the positions of the inlet and outlet were changed, and hydrogen sulfide was again fed into the reactor to minimize the portion of iron compounds containing oxygen that was not sulfided. This procedure was repeated to produce the sulfided adsorbent for removing mercury.

The results are described in Table 3.

### EXAMPLE 6

### Sulfidation of Iron Compounds Containing Oxygen and Removal of Hydrogen Sulfide

The procedure of example 5 was repeated except that iron compounds containing oxygen produced according to example 2 was used instead of iron compounds containing oxygen produced according to example 1.

The results are described in Table 3.

### EXAMPLE 7

### Sulfidation of Iron Compounds Containing Oxygen and Removal of Hydrogen Sulfide

The procedure of example 5 was repeated except that iron compounds containing oxygen produced according to example 3 was used instead of iron compounds containing oxygen produced according to example 1.

The results are described in Table 3.

### EXAMPLE 8

### Sulfidation of Iron Compounds Containing Oxygen and Removal of Hydrogen Sulfide

The procedure of example 5 was repeated except that iron compounds containing oxygen produced according to example 4 was used instead of iron compounds containing oxygen produced according to example 1.

The results are described in Table 3.

TABLE 3
Breakthrough time

| | Example 5 | Example 6 | Example 7 | Example 8 |
|---|---|---|---|---|
| Breakthrough time(min) | 1260 | 1175 | 947 | 1077 |

As shown in Table 3, it can be seen that iron compounds containing oxygen produced using polyferric sulfate and ammonium carbonate according to example 5 is capable of treating a relatively large amount of hydrogen sulfide in comparison with iron compounds containing oxygen produced according to examples 6 to 8, which means that more active sites for removing gaseous mercury are formed in iron compounds containing oxygen produced according to example 5 compared with other synthetic iron compounds containing oxygen.

### EXAMPLE 9

### Evaluation of Mercury Adsorption Ability

An SUS reactor was manufactured such that an inlet and an outlet were positioned opposite each other, the diameter was 25 mm, and the height was 200 mm. 20 cm³ of adsorbent for removing mercury, which was sulfided according to example 5, was packed therein.

Next, liquid mercury was charged in a gas reactor tube [glass processed goods] and bubbled at 25-28° C. to produce gaseous mercury, and gaseous mercury was fed through the inlet into the reactor at a flow rate of 90 cm³/min. Nitrogen was used as a carrier gas, and the total flow rate of gas containing mercury, fed into the reactor was maintained at 1000 cm³/min. The concentration is described in Table 4.

The concentration of mercury discharged through the outlet of the reactor was measured using a mercury analyzer [VM-3000, mercury instruments analytical technologies, Germany].

The results are described in Table 4.

### EXAMPLE 10

### Adsorption of Mercury

The procedure of example 9 was repeated except that an adsorbent for removing mercury produced according to example 6 was used instead of an adsorbent for removing mercury sulfided according to example 5.

The results are described in Table 4.

### EXAMPLE 11

### Adsorption of Mercury

The procedure of example 9 was repeated except that an adsorbent for removing mercury, produced according to example 7 was used instead of an adsorbent for removing mercury sulfided according to example 5.

The results are described in Table 4.

### EXAMPLE 12

### Adsorption of Mercury

The procedure of example 9 was repeated except that an adsorbent for removing mercury produced according to example 8 was used instead of an adsorbent for removing mercury was sulfided according to example 5.

The results are described in Table 4.

TABLE 4
Adsorption experiment of gaseous mercury

| | | Example | Example | Example |
|---|---|---|---|---|
| | Example 9 | 10 | 11 | 12 |
| Concentration | 1,480 ± 40 | 1,370 ± 40 | 1,310 ± 40 | 1,420 ± 40 |
| of fed mercury | | | | |
| (μg/m³ · min) | | | | |
| Time required | 733 | 698 | 492 | 695 |
| to remove | | | | |
| 50% of | | | | |
| mercury(min) | | | | |
| Total mercury | 1,085 ± 29 | 956 ± 28 | 644 ± 20 | 987 ± 28 |
| adsorption | | | | |
| amount for | | | | |
| time required | | | | |
| to remove | | | | |
| 50% of | | | | |
| mercury(mg) | | | | |

As shown in Table 4, it can be seen that synthetic iron compounds containing oxygen according to example 5, in which much hydrogen sulfide was adsorbed, has a high ability to adsorb a mercury element. This means that iron compounds containing oxygen produced using polyferric sulfate and ammonium carbonate according to example 1 can treat the most mercury among the iron compounds containing oxygen produced.

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

As described above, the present invention provides an adsorbent for removing gaseous mercury, in which iron compounds containing oxygen are sulfided to accumulate sulfur therein.

Furthermore, in the present invention, iron compounds containing oxygen are produced using waste generated from industrial facilities to create an adsorbent for removing mercury contained in exhausted gas, thereby reusing resources and reducing environmental pollution.

What is claimed is:

1. An adsorbent for removing mercury, comprising:
sulfided iron compounds containing oxygen.

2. The adsorbent as set forth in claim 1, wherein the mercury is Hg⁰, HgCl, or HgCl₂.

3. The adsorbent as set forth in claim 1, wherein the mercury is gaseous mercury discharged from a power plant, an incinerator, a mercury battery, an amalgam in a dental service, or a fluorescent mercury lamp.

4. The adsorbent as set forth in claim 1, wherein the iron compounds containing oxygen are selected from a group consisting of FeO, Fe(OH)₂, Fe(OH)₃, FeO(OH), Fe₂O₃, and Fe₃O₄.

5. The adsorbent as set forth in claim 1, wherein the iron compounds containing oxygen are sulfided by continuously supplying gas containing a sulfur compound to the iron compounds containing oxygen.

6. The adsorbent as set forth in claim 1, wherein the iron compounds containing oxygen are sulfided by impregnating the iron compounds containing oxygen with a solution containing sulfur, drying the iron compounds containing oxygen, and sintering the iron compounds containing oxygen.

7. The adsorbent as set forth in claim 1, wherein the iron compounds containing oxygen are sulfided by vaporizing a sulfur element at a high temperature, and depositing the vaporized sulfur element on the iron compounds containing oxygen.

8. A method of producing an adsorbent for removing mercury, comprising:
sulfurizing iron compounds containing oxygen.

9. The method as set forth in claim 8, further comprising conducting an extrusion step before or after the iron compounds containing oxygen are sulfided.

10. The method as set forth in claim 9, wherein the adsorbent for removing mercury is extruded into balls, tablets, pellets, or honeycombs.
